(19) United States
(12) Patent Application Publication
(10) Pub. No.: US 2020/0329347 A1
(43) Pub. Date: Oct. 15, 2020

(54) MULTICAST/BROADCAST SERVICE TO RADIO ACCESS NETWORKS WITH CORE NETWORKS

(71) Applicant: Nokia Solutions and Networks Oy, Espoo (FI)

(72) Inventors: Athul PRASAD, Helsinki (FI); David NAVRATIL, Helsinki (FI); Mikko SAILY, Laukkoski (FI)

(21) Appl. No.: 16/759,958

(22) PCT Filed: Nov. 16, 2018
(86) PCT No.: PCT/EP2018/081548

§ 371 Date: Apr. 28, 2020

Related U.S. Application Data
(60) Provisional application No. 62/587,081, filed on Nov. 16, 2017.

(51) Int. Cl. H04W 4/06; H04W 72/00; H04L 29/06; H04W 28/02; H04W 88/16

(52) U.S. Cl. CPC H04W 4/06; H04W 72/005; H04W 88/16; H04L 65/4076; H04W 28/0268; H04L 65/102

(57) ABSTRACT

Multicast and/or broadcast service may be provided to one or more radio access networks, such as using one or more multicast broadcast gateways and/or one or more nodes, such as coordination function nodes. A multicast broadcast gateway may be connected to a node via a control plane interface. The node may be associated with a base station configured to provide one or more of multicast transmissions or broadcast transmissions to user devices from a broadcast multicast core network. The multicast broadcast gateway may also be connected to the base station via a user plane interface. The multicast broadcast gateway may send, to the node and via the control plane interface, one or more control signals. The multicast broadcast gateway may send, to the base station and via the user plane interface, one or more user signals. The multicast broadcast gateway and/or node may be used to setup, update, and/or stop multicast and/or broadcast sessions.

### CROSS-REFERENCE TO RELATED APPLICATIONS

This application claims priority to U.S. Provisional Patent Application Ser. No. 62/587,081, filed Nov. 16, 2017 and entitled “Multicast/Broadcast Service to Radio Access Network with 5G Core Network.” The prior application is incorporated herein by reference in its entirety.

### BACKGROUND

Multicast and broadcast services have been used in existing wireless networks, such as in Third Generation (3G) and Fourth Generation (4G) LTE-Advanced wireless networks. Multicast and broadcast services may enable resource-efficient content distribution. Content distributed in such broadband networks may include, for example, television (TV) broadcasts, public safety broadcasts (e.g., public warning systems and mission critical communication systems), etc.

### BRIEF SUMMARY

This summary is provided to introduce a selection of concepts in a simplified form that are further described below in the Detailed Description. This Summary is not intended to identify key features or essential features of the various embodiments, nor is it intended to be used to limit the scope of the claims.

In some aspects, a multicast broadcast gateway may be connected to a node (e.g., a coordination function node) via a control plane interface. The node may be associated with a base station configured to provide one or more of multicast transmissions or broadcast transmissions to user devices from a broadcast multicast core network. The multicast broadcast gateway may be connected to the base station via a user plane interface. The multicast broadcast gateway may send, to the node and via the control plane interface, one or more control signals. The multicast broadcast gateway may send, to the base station and via the user plane interface, one or more user signals.

In some examples, the multicast broadcast gateway may receive, from a broadcast multicast service center of the broadcast multicast core network, a request to initiate a broadcast multicast session. The request may comprise a plurality of session attributes, and the plurality of session attributes may be stored. Sending the one or more control signals may comprise sending, to the node and via the control plane interface, one or more of the plurality of session attributes.

In some examples, the plurality of session attributes may comprise two or more of an access indicator, a service area, quality of service (QoS) information, a session duration, a session identifier, or a mobile group identity.

In some examples, the multicast broadcast gateway may receive, from the broadcast multicast service center of the broadcast multicast core network, a request to update the broadcast multicast session. The request to update may comprise a second plurality of session attributes, and the second plurality of session attributes may be stored. Sending the one or more control signals may comprise sending, to the node and via the control plane interface, one or more of the second plurality of session attributes.

In some examples, the multicast broadcast gateway may receive, from the broadcast multicast service center of the broadcast multicast core network, a request to stop the broadcast multicast session. Sending the one or more control signals may comprise forwarding, to the node and via the control plane interface, the request to stop the broadcast multicast session.

In some examples, the multicast broadcast gateway may comprise a management entity. The node may comprise a coordination entity. Connecting the multicast broadcast gateway to the node may comprise connecting the management entity to the coordination entity. Sending the one or more control signals may comprise sending, by the management entity and to the coordination entity, the one or more control signals.

In some examples, before connecting the multicast broadcast gateway to the node via the control plane interface, the multicast broadcast gateway may send, to the node and via a virtual interface, a request to set up the control plane interface between the multicast broadcast gateway and the node. The multicast broadcast gateway may receive, from the node and via the virtual interface, a response indicating setup of the control plane interface between the multicast broadcast gateway and the node.

In some examples, the node may comprise a management entity and a coordination entity. Connecting the multicast broadcast gateway to the node may comprise connecting the multicast broadcast gateway to the management entity. Sending the one or more control signals may comprise sending, to the management entity, the one or more control signals.

In some examples, an apparatus may comprise one or more processors and memory storing machine-readable instructions executable by the one or more processors to cause the apparatus to connect to a first node in a multicast/broadcast core network via a control plane interface and a user plane interface. The apparatus may also connect to a second node in a unicast core network via a second control plane interface and/or connect to a third node in the unicast core network via a second user plane interface. The apparatus may receive, from the first node and via the control plane interface, one or more control signals for multicast/broadcast management. The apparatus may additionally or alternatively receive, from the first node and via the user plane interface, one or more user signals.

In some examples, receiving the one or more control signals may comprise receiving one or more of a plurality of session attributes associated with a multicast/broadcast session. The plurality of session attributes may comprise, for example, two or more of an access indicator, a service area, quality of service (QoS) information, a session duration, a session identifier, or a mobile group identity.

### BRIEF DESCRIPTION OF THE DRAWINGS

Some embodiments are illustrated by way of example, and not by way of limitation, in the figures of the accompanying drawings.

FIG. 1 is a diagram showing an overview of a content delivery mechanism in the context of multicast/broadcast networks.

FIG. 2 is a block diagram showing an example of a Fifth Generation (5G)/New Radio (NR) architecture.

FIG. 3 is a block diagram of an example communication system in which one or more embodiments may be implemented.

FIG. 4 is a block diagram of another example communication system in which one or more embodiments may be implemented.

FIG. 5 is a block diagram of yet another example communication system in which one or more embodiments may be implemented.

FIG. 6 shows an example of signaling for a setup procedure according to one or more embodiments described herein.

FIG. 7 shows an example of signaling for a configuration update procedure according to one or more embodiments described herein.

FIG. 8 shows an example of a session start procedure according to one or more embodiments described herein.

FIG. 9 shows another example of a session start procedure according to one or more embodiments described herein.

FIG. 10 shows an example of a session update procedure according to one or more embodiments described herein.

FIG. 11 shows another example of a session update procedure according to one or more embodiments described herein.

FIG. 12 shows an example of a session stop procedure according to one or more embodiments described herein.

FIG. 13 shows another example of a session stop procedure according to one or more embodiments described herein.

FIG. 14 is a block diagram of an example communication system in which one or more embodiments may be implemented.

FIG. 15 is an example computing device in which one or more embodiments may be implemented.

### DETAILED DESCRIPTION

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

Rising quality requirements and increasing time criticality associated with content delivery has resulted in a continued increase in the amount of radio resources used to distribute various forms of content, such as multicast/broadcast (MC/BC) content. Content quality requirements have continued to increase, such as with advanced video and audio codecs enhancing quality of experience for end users. Network operators may allocate higher amounts of radio resources, which may allow more efficient and effective delivery of MC/BC content to end users. The scarce amount of available spectral resources may make over-the-air delivery of such content increasingly challenging, such as when media is broadcasted over a wide area.

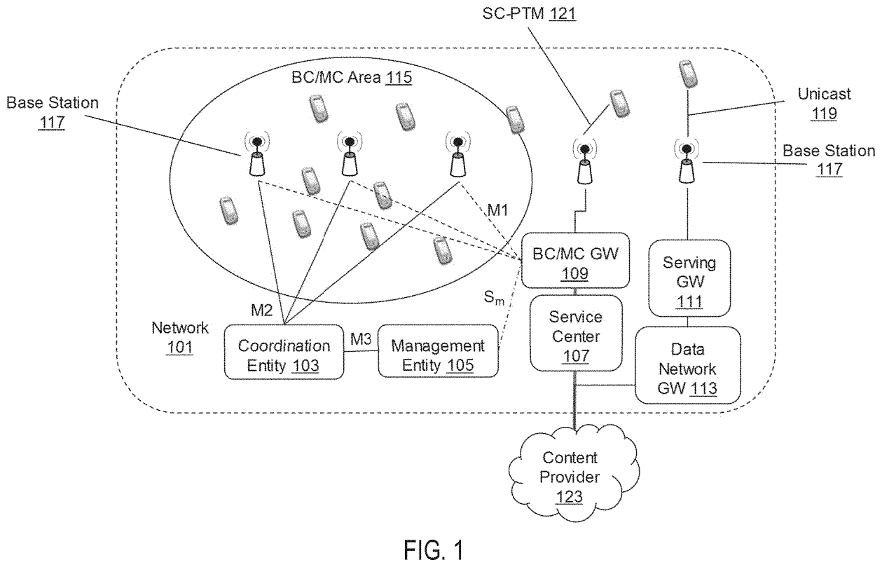

FIG. 1 is a diagram showing an overview of a content delivery mechanism in the context of multicast/broadcast networks. The network 101 may comprise, for example, a Fourth Generation (4G)/Long Term Evolution (LTE) network or other type of 3rd Generation Partnership Project (3GPP) network. The network 101 may be used to provide content to user equipment (UE), such as mobile phones, tablet computers, personal digital assistants (PDAs), etc. Content may be sent to UEs using one or more base stations (BS) 117, which may include, for example, evolved NodeBs (eNB) (e.g., in a 4G network). In some examples, content may be unicast 119 to a UE, such as via a base station 117 connected to a serving gateway (S-GW) 111. The serving gateway 111 may be connected to a data network gateway 113, such as a packet data network gateway (P-GW), which may receive, from a content provider 123, the content to be sent to the UE. In some examples, content may be sent to a UE using Single Cell Point-to-Multipoint (SC-PTM) 121. For example, a service center 107, such as a Broadcast Multicast Service Center (BMSC), may receive the content from the content provider 123. The service center 107 may use a broadcast/multicast gateway 109, such as an evolved Multimedia Broadcast/Multicast Service (MBMS) gateway (MBMS-GW), to send the content to the UE via SC-PTM 121.

In some examples, content may be sent to one or more UEs via broadcast and/or multicast techniques. For example, the network 101 may comprise a management entity 105, such as a Mobility Management Entity (MME), which may be connected to and communicate with the BC/MC GW 109. The network may comprise a coordination entity 103, such as a Multi-cell/multicast Coordination Entity (MCE), which may be connected to and communicate with the management entity 105. Broadcast/multicast service, such as evolved Multimedia Broadcast/Multicast Service (eMBMS), may be provided to UEs within a BC/MC area 115 via one or more base stations 117. The BC/MC area 115 may comprise, for example, a Multimedia Broadcast multicast service Single Frequency Network (MB SFN) area. The coordination entity 103 (e.g., an MCE) may be used to enable the setting up of, for example, MBSFN transmissions and mode selection between an MBSFN and a SC-PTM.

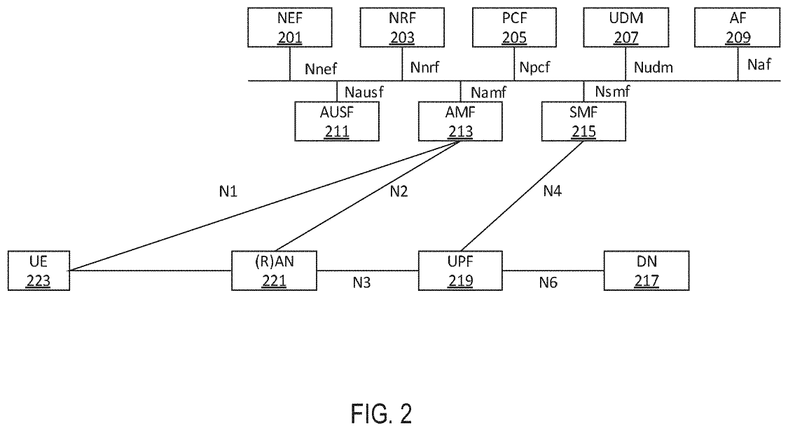

FIG. 2 is a block diagram showing an example of a Fifth Generation (5G)/New Radio (NR) architecture. In some examples, the block diagram in FIG. 2 may use the Fifth Generation (5G)/New Radio (NR) architecture described in the 3GPP technical standard document titled “3rd Generation Partnership Project; Technical Specification Group Services and System Aspects; System Architecture for the 5G System; Stage 2 (Release 15),” 3GPP TS 23.501 v1.5.0 (2017-11), which document is incorporated by reference herein.

The architecture shown in FIG. 2 may comprise one or more network functions, such as an NEF 201 (Network Exposure Function), a NRF 203 (Network Repository Function), a PCF 205 (Policy Control Function), a UDM 207 (Unified Data Management), an AF 209 (Application Function), an AUSF 211 (Authentication Server Function), an AMF 213 (Access and Mobility Management Function), an SMF 215 (Session Management Function), a UPF 219 (User Plane Function), and/or other network functions. The network functions 201-215 and 219 may communicate with one another via any type of communication link, such as an IP-based communication link, a virtual network link, a logical connection, etc. The network functions 201-215 and 219 may perform similar functions as the similarly named network functions described in the 3GPP technical standard document titled “3rd Generation Partnership Project; Technical Specification Group Services and System Aspects; System Architecture for the 5G System; Stage 2 (Release 15),” 3GPP TS 23.501 v1.5.0 (2017-11).

The architecture shown in FIG. 2 may comprise a data network (DN) 217. The data network may comprise one or a plurality of data distribution networks, such as, an optical fiber network, a coaxial cable network, a hybrid fiber coax network, an Internet Protocol (IP) based network (e.g., the Internet), and the like. Radio Access Networks (RANs) may interwork with the network functions 201-215 and 219. For example, one or more of the various network functions 201-215 and 219 may be used to manage connections between the data network 217 and one or more access networks, such as a RAN 221. RAN 221 may communicate with one or more UEs 223 using, for example, a 5G air interface or LTE-pro (also called evolved LTE or eLTE).

Network operators with, for example, existing LTE eMBMS deployments may seek an efficient migratory path toward upgrade of their networks to 5G/NR. In some scenarios, 5G/NR architectures may have only been defined for unicast transmissions. Because 5G/NR architectures might only support unicast, however, deployment of multicast/broadcast services in a 5G/NR network might not be possible in known configurations of a 5G/NR network. Another current limitation of 5G/NR networks is that, after upgrading to a 5G core network, LTE eMBMS services might not work. This can be due to limitations in the network architecture design, such as removing the management entity 105 (e.g., MME) found in 4G networks and replacing it with AMF and/or SMF functionalities in a 5G network.

Because of the software components involved, and before deploying a complete 5G network, a network may be upgraded to use, for example, an LTE-Pro or evolved/enhanced LTE (eLTE) air interface with a 5G core network. In such a scenario, however, there may remain the problem of how to enable multicast/broadcast service provisioning using an LTE-Pro/5G network with minimal implementation-specific enhancements, while also using an existing LTE eMBMS deployment.

Existing 3GPP specifications may assume the presence of an MME in order to provide control plane connectivity from an eMBMS Gateway (MBMS-GW) to a radio access network. Those specifications include, for example, 3GPP TS 23.246, “Multimedia Broadcast/Multicast Service (MBMS); Architecture and functional description (Release 14),” v14.2.0 (September 2017) (“3GPP TS 23.246 v14.2.0”) and 3GPP TS 36.300, “E-UTRA and E-UTRAN; Overall description; Stage 2 (Release 14),” v14.2.0 (March 2017) (“3GPP TS 36.300 v14.2.0”), both of which are incorporated by reference herein. Known multicast solutions may be built on this assumption, which was an extension of the LTE unicast system defined in 3GPP Release 8.

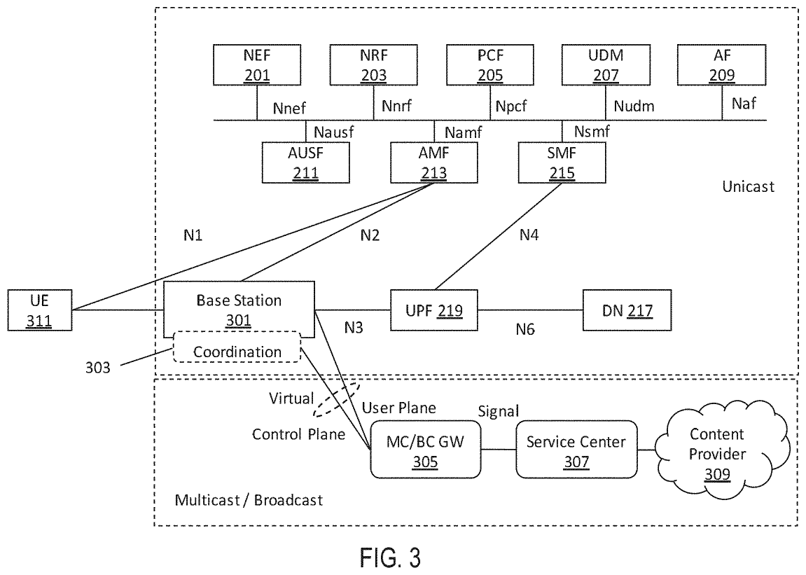

Methods and systems described herein offer enhancements to providing multicast and/or broadcast service to user devices. FIG. 3 is a block diagram of an example communication system in which one or more embodiments may be implemented. For example, a multicast/broadcast path from a content provider 309 may be provided to a radio access network that may use, for example, a 5G core network for unicast service. Mobility management functionalities of a mobile network, such as an LTE, 5G, or other network, may include an enhanced multicast/broadcast (MC/BC) gateway 305 having MC/BC gateway functionality (MC/BC GWF). An interface between an MC/BC core network and a (R)AN may comprise a user plane link to a base station 301, such as an eNB or a gigabit or next generation NodeB (gNB), and/or a control plane link to a node, such as a coordination function (CoordF) node 303. This interface may be modified to support starting, updating, modification, and/or stopping an MC/BC session, as will be described in further detail below. Accordingly, an MC/BC overlay path may be provided from the content provider 309 to the radio access network. In some examples, the overlay path may operate in parallel with a 5G core network for unicast. For example, the base station 301 may also connect to a node (e.g., AMF 213) in the unicast core network via another control plane interface (e.g., N2). Additionally or alternatively, the base station 301 may connect to a node (e.g., UPF 219) in the unicast core network via another user plane interface (e.g., N3). By connecting to a multicast/broadcast core network and a unicast core network, the base station 301 may multicast/broadcast content to one or more UEs 311 connected to the base station 301 and/or send unicast content to a UE connected to the base station 301.

Operations of an MC/BC GWF may be performed by the MC/BC GW 305. The MC/BC GW 305 may support control (C) plane and/or user (U) plane connections (e.g., links) to the base station 301 (e.g., a (R)AN). For example, the MC/BC GW 305 may connect to the coordination function node 303 (which may be associated with the base station 301) via a control plane interface. The MC/BC GW 305 may send, to the coordination function node 303 and via the control plane interface, one or more control signals. The control signals may be used for multicast/broadcast management. The MC/BC GW 305 may also connect to the base station 301 via a user plane interface. The MC/BC GW 305 may send, to the base station 301 and via the user plane interface, one or more user signals. As will be described in further detail below, the base station 301 may be configured to provide one or more of multicast transmissions or broadcast transmission to user devices from the broadcast multicast core network.

The MC/BC GW 305 may comprise an enhancement of an existing MBMS-GW. As part of the MC/BC GW 305, existing MBMS-GW functionalities may be enhanced to maintain a list of coordination function nodes serving a particular MBMS service, such as coordination function node 303 and/or other coordination function nodes. A virtual interface (e.g., an Mx interface) may be used to support the control plane and/or user plane links. The virtual interface may comprise an enhancement of the M1 interface and the M3 interface described in 3GPP TS 36.444, “Evolved Universal Terrestrial Radio Access Network (E-UTRAN); M3 Application Protocol (M3AP),” v14.1.0 (June 2017) (“3GPP TS 36.444 v14.1.0”), which is incorporated by reference herein. Use of the virtual interface will be described in more detail below. The MC/BC GW 305 may be connected to a service center 307 (e.g., a BMSC). The service center 307 may be connected to the content provider 309 of multicast/broadcast content.

The coordination function node 303 may be, or include, an enhancement of an existing MCE and/or base station (e.g., eNB). As previously explained, an MCE may be used to enable the setting up of, for example, MBSFN transmissions and mode selection between an MBSFN and a SC-PTM. In some methods and systems described herein, the coordination function node 303 may exchange signaling with the MC/BC GW 305 to create, update, and/or stop multicast/broadcast sessions (e.g., MBMS sessions) to transport multicast/broadcast content to the base station 301 (e.g., eNB), which may be associated with the coordination function node 303. Operations of a coordination function may be performed by the coordination function node 303. Other base stations (not shown) may similarly be associated with their respective coordination function node(s) and connected to the MC/BC GW 305 for facilitating transmission of multicast/broadcast content to UEs.

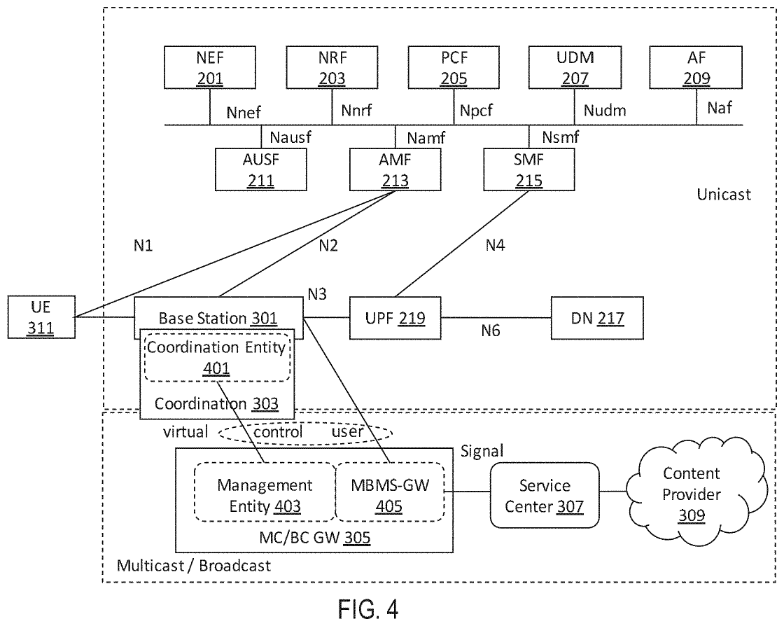

FIG. 4 is a block diagram of another example communication system in which one or more embodiments may be implemented. For example, mobility management functions for MC/BC may be implemented at the MC/BC GW 305. In the example shown in FIG. 4, the coordination function node 303 may include coordination entity 401 (e.g., modified MCE) functionality, and the MC/BC GW 305 may include management entity 403 (e.g., modified MME) functionality and modified MBMS-GW functionality. The coordination function node 303 may be associated with, such as being part of, the base station 301 (e.g., an eNB), and may provide the coordination entity 401 (e.g., MCE) functionality. In some examples, a single coordination function node may be deployed for multiple base stations.

A virtual (e.g., Mx) interface from the MC/BC GW 305 to the base station 301 may include separate control plane (e.g., Mx-c or M3) and user plane (e.g., Mx-u or M1) interfaces, each interface with its corresponding functionalities and signalling aspects. The MC/BC GW 305 may support a control plane interface setup functionality with the coordination entity 401 of the coordination function node 303, along with configuration update, error reporting, and/or other functionalities. The control plane interface may use implementation specific signalling and/or reuse, for example, M1-AP signalling. The control plane interface may support IPV4 addresses, IPV6 addresses, or other network addresses. The control plane interface may engage in session management using, for example, session control signalling on the System Architecture Evolution (SAE) bearer level. The example implementation shown in FIG. 4 may simplify service center 307 (e.g., BMSC) operation and configuration because it might not be necessary to configure the service center 307 with a list of second level downstream nodes (e.g., management entities, such as MMEs), and the service center 307 might not need to send such a list in session procedures.

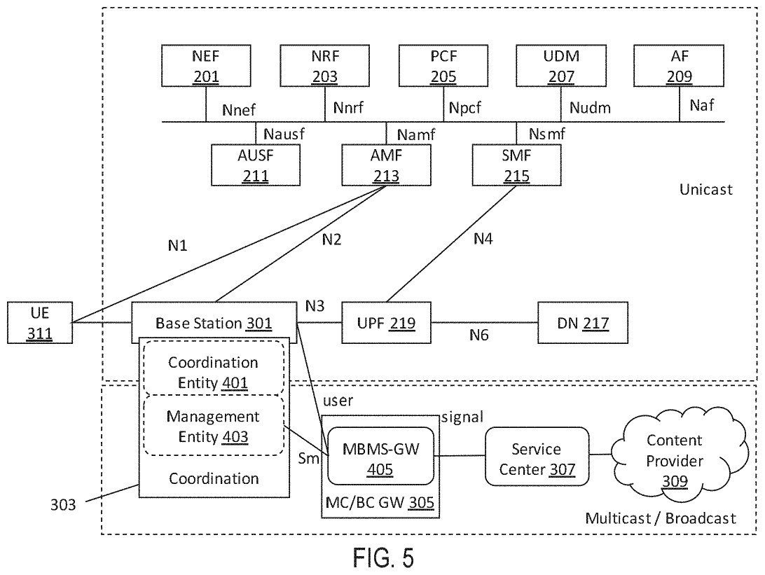

FIG. 5 is a block diagram of another example communication system in which one or more embodiments may be implemented. For example, enhanced functions for mobility management in MC/BC may be located at a coordination function node 303 through enhancements to coordination entity 401 (e.g., MCE) and base station 301 functionalities. In the example implementation of FIG. 5, the coordination function node 303 may include coordination entity 401 (e.g., modified MCE) functionality and management entity 403 (e.g., MME) functionality. The MC/BC GW 305 may include modified MBMS-GW 405 functionality. The coordination function node 303 shown in FIG. 5 may be associated with (e.g., be part of) the base station 301, such as an eNB or gNB.

There may be a distributed mobility management functionality that includes an interface (e.g., an Sm interface) between the MC/BC GW 305 (e.g., in a core network) and the coordination function node 303 (e.g., located within the base station 301). In some examples, the interface may be used to configure MBMS session parameters. Additionally or alternatively, the interface may support Evolved Packet System (EPS) general packet radio service (GPRS) tunnelling protocol (GTP), such as GTP version 2 (GTPv.2) messages or implementation-specific variants for signalling session messages, such as start, update, and/or stop messages. The example implementation shown in FIG. 5 may have less complexity than the example implementation shown in FIG. 4 in some respects. In some examples, deployment of a single coordination function node, such as coordination function node 303, per base station (e.g., eNB or gNB) may be used in the example implementation shown in FIG. 5. The user plane interface (e.g., M1 interface) might not require modification from existing M1 interfaces in the example implementation shown in FIG. 5. As previously explained, in the example implementation of FIG. 4, an MBMS-GW 405 of the MC/BC GW 305 might not need to receive a list of downstream nodes from the service center 307 (e.g., BMSC). This may simplify configuration at the service center 307, as the service center 307 in FIG. 4 might not need to select a list of MBMS-GWs and management entities (e.g., MMEs) for an MBMS session.

Operations, various procedures, and related signaling used in methods according to the implementations of FIGS. 4 and 5 are described below. In such methods, a UE (e.g., a mobile device) and a base station (e.g., an eNB or gNB) may each conform to LTE-Pro standards and support eMBMS functionality. Moreover, the base station may be connected to a 5G core network. The methods may enable the connectivity of such a 5G core network to a multicast/broadcast content provider (e.g., the content provider 309 shown in FIGS. 4 and 5) using a coordination function node 303, which may be located in a (R)AN, and an MC/BC GW 305, which may be located in the core network. Procedures described below may be modified, e.g., from existing procedures described in 3GPP TS 23.246 v14.2.0 and 3GPP TS 36.300 v14.2.0, to carry out the operations described herein.

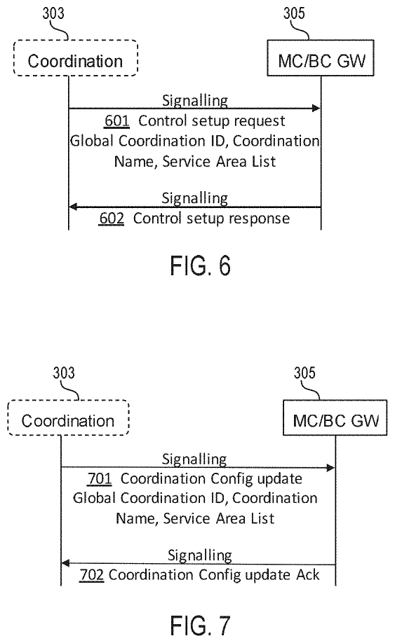

FIG. 6 shows an example of signaling for a setup procedure according to one or more embodiments described herein. For example, the signaling may be used to set up the control plane interface (e.g., an Mx-c interface) shown in the example implementation of FIG. 4. The signalling shown in FIG. 6 may enable a coordination function node 303 and a MC/BC GW 305 to exchange application level information for interoperability, similar to the M3 setup procedure described in 3GPP TS 36.444 v14.1.0. The setup procedure and configuration update procedure may be used to inform the upstream nodes (e.g., MC/BC GW 305) about the configuration (e.g., MBMS service areas) of downstream nodes. The configuration in the upstream nodes may be used to select the list of involved downstream nodes without the need, for example, for operation and maintenance (O&M) configuration in the upstream nodes.

In step 601, the coordination function node 303 may send, to the MC/BC GW 305 and via a virtual interface (e.g., an Mx interface), a request to setup a control plane (e.g., an Mx-c) interface. For example, the coordination entity 401 of the coordination function node 303 may be used to send the request to setup the control plane. The request may comprise setup parameters, such as a global identifier for the coordination function node 303 and/or the coordination entity 401 and/or other identifiers for the coordination function node 303 and/or the coordination entity 401. The request may comprise an indication of the service area associated with the coordination function node 303, such as an MBMS service area. In step 602, the MC/BC GW 305 may send, to the coordination function node 303 and via the virtual interface, a response indicating setup of the control plan interface.

One or more of the steps shown in FIG. 6 may be performed over the control plane interface shown in the example implementation of FIG. 4, but might not be performed in the example implementation of FIG. 5. For example, in the example implementation of FIG. 5, the coordination function node 303 may support both coordination entity 401 (e.g., MCE) and management entity 403 (e.g., MME) functionalities. Also, in the example implementation of FIG. 5, there may be a configuration of multiple coordination functions nodes in the service center 307 (e.g., a BMSC).

FIG. 7 shows an example of signaling for a configuration update procedure according to one or more embodiments described herein. For example, one or more of the steps shown in FIG. 7 may be used for a coordination function node 303 and/or coordination entity 401 configuration update procedure in the example implementation of FIG. 4. In step 701, the coordination function node 303 may send, to the MC/BC GW 305 and via a virtual interface (e.g., an Mx interface), a request to update configuration parameters. For example, the coordination entity 401 of the coordination function node 303 may be used to send the request to update configuration parameters. The request may comprise parameters, such as a global identifier for the coordination function node 303 and/or the coordination entity 401 and/or other identifiers for the coordination function node 303 and/or the coordination entity 401. The request may comprise an indication of the service area associated with the coordination function node 303, such as an MBMS service area. In step 702, the MC/BC GW 305 may send, to the coordination function node 303 and via the virtual interface, a response acknowledging the configuration update.

Similar to the setup procedure of FIG. 6, one or more of the steps shown in FIG. 7 may be performed over the control plane interface shown in the example implementation of FIG. 4. For the example implementation of FIG. 5, such updates may be done locally within the coordination function node 303, as needed.

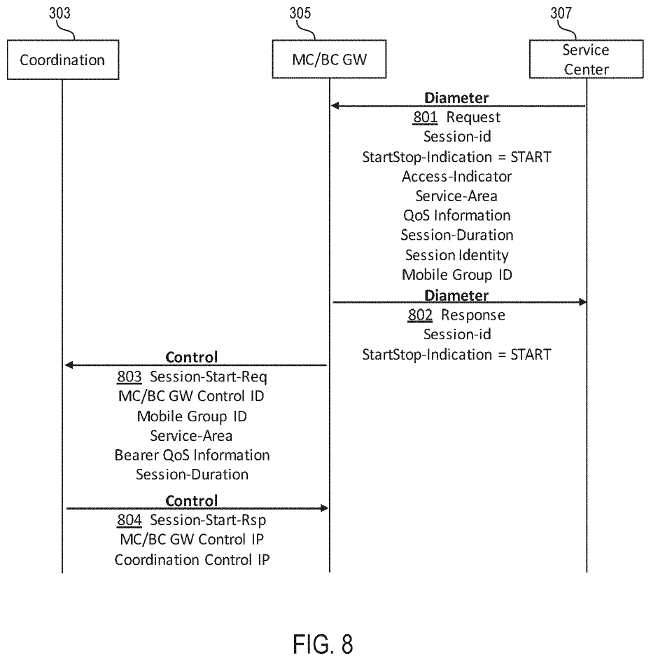

FIG. 8 shows an example of a session start procedure according to one or more embodiments described herein. For example, the session start procedure shown in FIG. 8 may be used in the example implementation of FIG. 4. The session start procedure may be initiated by the service center 307. In step 801, the service center 307 may send, to the MC/BC gateway 305, a request, such as a Diameter Re-Authorization Request (RAR), to indicate the initiation of an MC/BC transmission. The request sent in step 801 may comprise one or more session attributes, such as a start indication (e.g., an MBMS start indication), an access indicator (e.g., an MBMS access indicator), an indication of the multicast/broadcast service area (e.g., an MBMS service area), quality of service (QoS) information, an estimated duration of the session, a session identifier, a mobile group identity (e.g., a temporary mobile group identity (TMGI)), a flow identifier, a list of control plane nodes (e.g., MC/BC GW 305 for the example implementation of FIG. 4), etc. The MC/BC gateway 305 may receive the session start message from the service center 307, and the MC/BC gateway 305 may create an MBMS bearer context and/or store one or more of the received session attributes. In step 802, the MC/BC gateway 305 may send, to the service center 307, a response message (e.g., an RAA response message) acknowledging receipt of the request to start of the MC/BC session.

The MC/BC GW 305 may signal session start parameters received from the service center 307 to an appropriate coordination function node 303 and/or the coordination entity 401 or set of coordination function nodes 303 and/or the coordination entities 401 that are part of the broadcast or multicast session. In step 803, the MC/BC GW 305 may initiate a session start request message towards the coordination function node 303, which may comprise a coordination entity 401 (e.g., an MCE). The MC/BC GW 305 may set up the control plane link (e.g., an Mx-c link) to communicate with the coordination function node 303 and/or the coordination entity 401. The session start request message may comprise one or more session attributes, such as an identifier for the MC/BC GW control plane (e.g., Mx-c), a mobile group identity (e.g., TMGI), an indication of the multicast/broadcast service area (e.g., an MBMS service area), QoS information (e.g., Evolved Universal Terrestrial Radio Access Network (E-UTRAN) Radio Access Bearer (E-RAB) QoS parameters), the session duration, etc. The coordination function node 303 and/or the coordination entity 401 may create an MBMS bearer context and/or may store one or more of the received session attributes. In step 804, the coordination function node 303 and/or the coordination entity 401 may report the result of the request via a session start response message. The response message may indicate, for example, an Internet Protocol (IP) address for the MC/BC GW control plane and/or an IP address for the coordination function node 303 and/or the coordination entity 401.

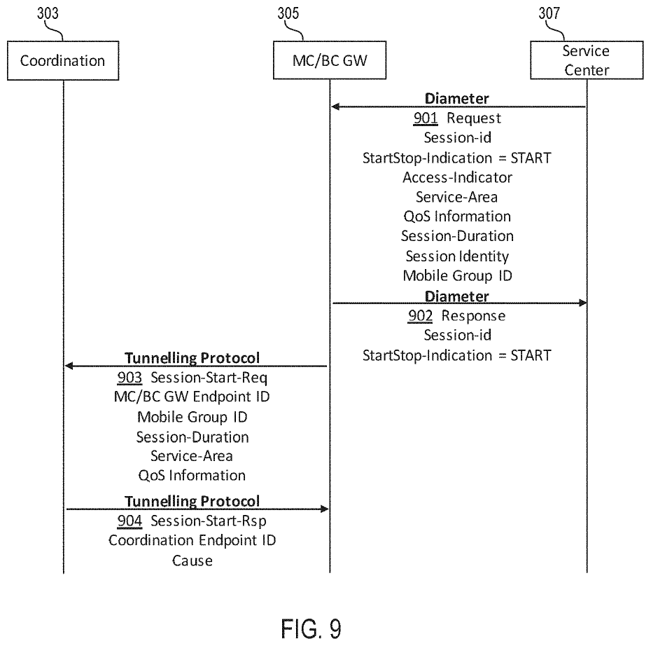

FIG. 9 shows another example of a session start procedure according to one or more embodiments described herein. For example, the session start procedure shown in FIG. 9 may be used in the example implementation of FIG. 5. The session start procedure may be initiated by the service center 307. In step 901, the service center 307 may send, to the MC/BC gateway 305, a request, such as a RAR in order to indicate the initiation of an MC/BC transmission. The request sent in step 901 may comprise one or more session attributes, such as a start indication (e.g., an MBMS start indication), an access indicator (e.g., an MBMS access indicator), an indication of the multicast/broadcast service area (e.g., an MBMS service area), QoS information, an estimated duration of the session, a session identifier, a mobile group identity (e.g., a TMGI), a flow identifier, a list of control plane nodes (e.g., coordination function nodes 303 for the example implementation of FIG. 5), etc. The MC/BC gateway 305 may receive the session start message from the service center 307, and the MC/BC gateway 305 may create the MBMS bearer context and/or store one or more of the received session attributes. In step 902, the MC/BC gateway 305 may send, to the service center 307, a response message (e.g., an RAA response message) acknowledging receipt of the request to start of the MC/BC session.

The MC/BC GW 305 may signal session start parameters received from the service center 307 to an appropriate coordination function node 303 and/or the coordination entity 401 for the broadcast or multicast session. In step 903, the MC/BC GW 305 may initiate a session start request message towards the coordination function node 303, which may comprise a coordination entity 401. The MC/BC GW 305 may use, for example, a general packet radio service (GPRS) tunnelling protocol (GTP), such as GTP version 2 (GTPv.2), to communicate with the coordination function node 303. For example, the MC/BC GW 305 may forward Sm signalling for session setup to the coordination function node 303 using GTPv.2. The session start request message may comprise one or more session attributes, such as an identifier for the MC/BC GW endpoint (e.g., a tunnel endpoint identifier (TED) for the MC/BC GW 305), a mobile group identity (e.g., TMGI), an indication of the multicast/broadcast service area (e.g., an MBMS service area), QoS information, the session duration, etc. The coordination function node 303 and/or the coordination entity 401 may store one or more of the received session attributes. In step 904, the coordination function node 303 and/or the coordination entity 401 may report the result of the request via a session start response message. The response message may indicate, for example, an endpoint identifier for the coordination function node 303 (e.g., a TEID for the coordination function node 303).

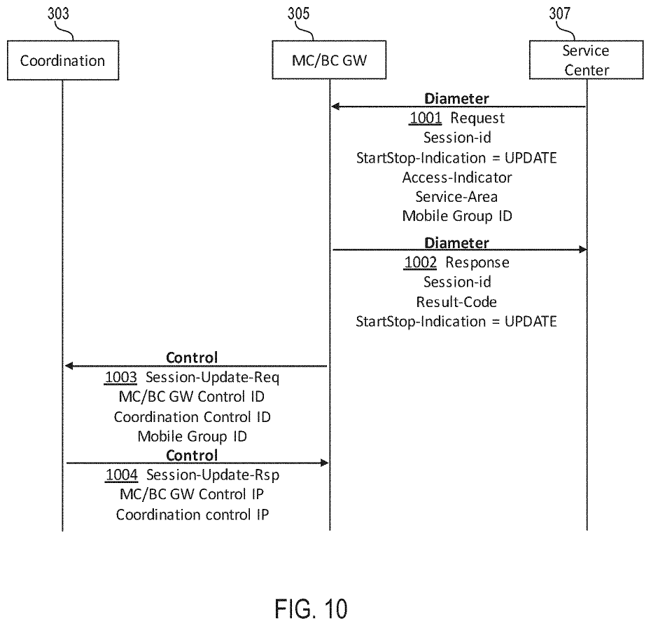

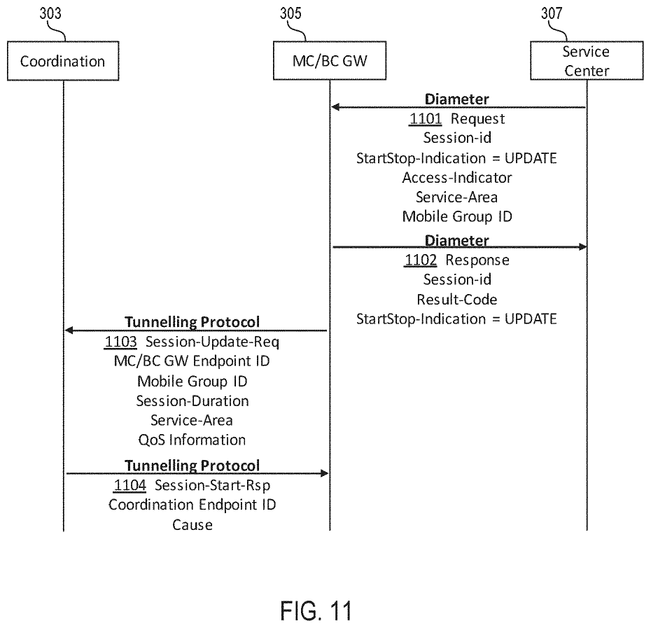

FIG. 10 shows an example of a session update procedure according to one or more embodiments described herein. FIG. 10 shows a modified session update procedure applicable to the example implementation of FIG. 4. The MC/BC GW 305 may maintain a list of appropriate set of coordination function nodes (e.g., coordination function node 303) that would be serving the session. The MC/BC GW 305 may receive signal session update parameters from a service center 307 and may forward one or more of the update parameters to the appropriate set of coordination function node(s) in order to update the parameters of the ongoing MC/BC sessions (e.g., MBMS sessions). The MC/BC gateway 305 may receive acknowledgement messages from the coordination function node(s).

The session update procedure may be initiated by the service center 307. For the example implementation of FIG. 4, the service center 307 may be configured with an appropriate set of MC/BC GWs, which may be part of the control plane nodes (e.g., MBMS control plane nodes). In step 1001, the service center 307 may send, to the MC/BC gateway 305, a request, such as a Diameter RAR, to indicate the update of parameters for an MC/BC session. The request sent in step 1001 may comprise one or more session attributes, such as an update indication (e.g., an MBMS update indication), an access indicator (e.g., an MBMS access indicator), an indication of the multicast/broadcast service area (e.g., an MBMS service area), a session identifier, a mobile group identity (e.g., a TMGI), a list of control plane nodes (e.g., MC/BC GW 305 for the example implementation of FIG. 4), etc. The MC/BC gateway 305 may receive the session update message from the service center 307, and the MC/BC gateway 305 may store one or more of the received session attributes. In step 1002, the MC/BC gateway 305 may send, to the service center 307, a response message (e.g., an RAA response message) acknowledging receipt of the request to update the MC/BC session. The response may also include a result code.

The MC/BC GW 305 may signal session update parameters received from the service center 307 to an appropriate coordination function node 303 and/or the coordination entity 401 that are part of the broadcast or multicast session. In step 1003, the MC/BC GW 305 may initiate a session update request message towards the coordination function node 303, which may comprise a coordination entity 401. The MC/BC GW 305 may use the control plane link (e.g., an Mx-c link) to communicate updates with the coordination function node 303 and/or the coordination entity 401. The session update request message may comprise one or more session attributes, such as the identifier for the MC/BC GW control plane (e.g., Mx-c), the identifier for the coordination function node 303 control plane (e.g., Mx-c), a mobile group identity (e.g., TMGI), etc. The coordination function node 303 and/or the coordination entity 401 may store one or more of the received session attributes. In step 1004, the coordination function node 303 and/or the coordination entity 401 may report the result of the request via a session update response message. The response message may indicate, for example, an IP address for the MC/BC GW control plane and/or an IP address for the coordination function node 303 and/or the coordination entity 401.

FIG. 11 shows another example of a session update procedure according to one or more embodiments described herein. FIG. 11 shows a modified session update procedure applicable to the implementation of FIG. 5. The session update procedure may be initiated by the service center 307. For the example implementation of FIG. 5, based on the control plane node information, the MC/BC GW 305 may take appropriate action for routing and/or forwarding the session update message. In step 1101, the service center 307 may send, to the MC/BC gateway 305, a request, such as a Diameter RAR in order to indicate the update of parameters for an MC/BC session. The request sent in step 1101 may comprise one or more session attributes, such as an update indication (e.g., an MBMS update indication), an access indicator (e.g., an MBMS access indicator), an indication of the multicast/broadcast service area (e.g., an MBMS service area), a session identifier, a mobile group identity (e.g., a TMGI), a list of control plane nodes (e.g., coordination function nodes 303 for the example implementation of FIG. 5), etc. The MC/BC gateway 305 may receive the session update message from the service center 307, and the MC/BC gateway 305 may store one or more of the received session attributes. In step 1102, the MC/BC gateway 305 may send, to the service center 307, a response message (e.g., an RAA response message) acknowledging receipt of the request to update the MC/BC session. The response may also include a result code.

The MC/BC GW 305 may signal session update parameters received from the service center 307 to an appropriate coordination function node 303 and/or the coordination entity 401 for the broadcast or multicast session. In step 1103, the MC/BC GW 305 may initiate a session update request message towards the coordination function node 303, which may comprise a coordination entity 401 (e.g., an MCE). The MC/BC GW 305 may use, for example, a GTP, such as GTPv.2, to communicate updates with the coordination function node 303. The session update request message may comprise one or more session attributes, such as the identifier for the MC/BC GW endpoint (e.g., a TED for the MC/BC GW 305), a mobile group identity (e.g., TMGI), an indication of the multicast/broadcast service area (e.g., an MBMS service area), QoS information, the session duration, etc. The coordination function node 303 and/or the coordination entity 401 may store one or more of the received session attributes. In step 1104, the coordination function node 303 and/or the coordination entity 401 may report, to the MC/BC GW 305, the result of the request via a session update response message. The response message may indicate, for example, an endpoint identifier for the coordination function node 303 (e.g., a TEID for the coordination function node 303).

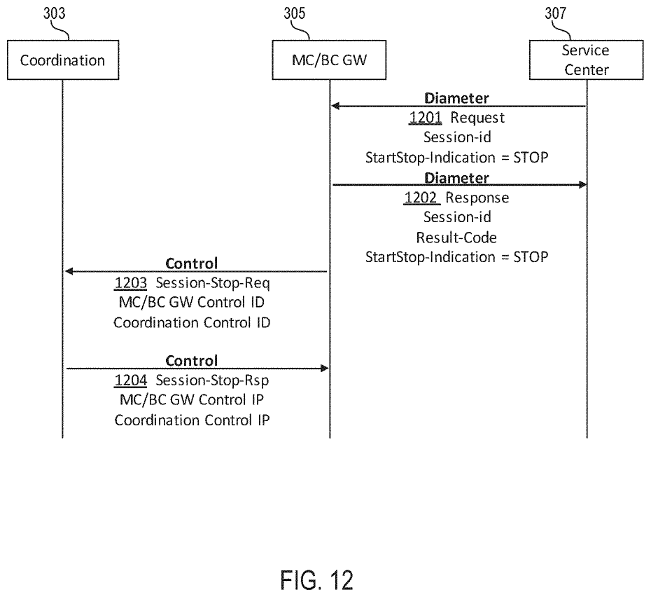

FIG. 12 shows an example of a session stop procedure according to one or more embodiments described herein. FIG. 12 shows a modified session stop procedure applicable to the implementation of FIG. 4. For example, the MC/BC gateway 305 may receive a session stop signal from the service center 307 (e.g., BMSC), and the MC/BC gateway 305 may forward the session stop request to the coordination function nodes with the appropriate session parameters indicating the end of the multicast/broadcast (e.g., MBMS) session.

The session stop procedure may be initiated by the service center 307. In step 1201, the service center 307 may send, to the MC/BC gateway 305, a request, such as a Diameter RAR, to indicate stopping the MC/BC session. The MC/BC gateway 305 may receive the session stop message from the service center 307. In step 1202, the MC/BC gateway 305 may send, to the service center 307, a response message (e.g., an RAA response message) acknowledging receipt of the request to stop the MC/BC session. The response may also include a result code.

The MC/BC GW 305 may send the session stop message received from the service center 307 to an appropriate coordination function node 303 and/or the coordination entity 401 that are part of the broadcast or multicast session, along with proper context update. In step 1203, the MC/BC GW 305 may initiate a session stop request message towards the coordination function node 303, which may comprise a coordination entity 401 (e.g., an MCE). The MC/BC GW 305 may use the control plane link (e.g., an Mx-c link) to communicate session stop requests with the coordination function node 303 and/or the coordination entity 401. The session stop request message may comprise one or more identifiers, such as the identifier for the MC/BC GW control plane (e.g., Mx-c) and/or the identifier for the coordination function node 303 control plane (e.g., Mx-c). In step 1204, the coordination function node 303 and/or the coordination entity 401 may report, to the MC/BC GW 305, the result of the request via a session stop response message. The response message may indicate, for example, the IP address for the MC/BC GW control plane and/or an IP address for the coordination function node 303 and/or the coordination entity 401.

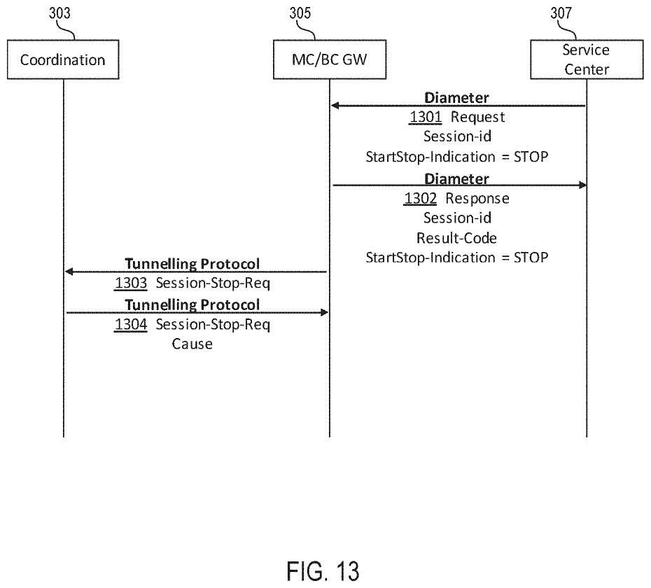

FIG. 13 shows another example of a session stop procedure according to one or more embodiments described herein. FIG. 13 shows a modified session stop procedure applicable to the implementation of FIG. 5. The session stop procedure may be initiated by the service center 307. In step 1301, the service center 307 may send, to the MC/BC gateway 305, a request, such as a Diameter RAR to indicate stopping the MC/BC session. The MC/BC gateway 305 may receive the session stop message from the service center 307. In step 1302, the MC/BC gateway 305 may send, to the service center 307, a response message (e.g., an RAA response message) acknowledging receipt of the request to stop the MC/BC session. The response may also include a result code.

The MC/BC GW 305 may send the session stop message received from the service center 307 to an appropriate coordination function node 303 and/or the coordination entity 401 for the broadcast or multicast session, along with proper context update. In step 1303, the MC/BC GW 305 may initiate a session stop request message towards the coordination function node 303, which may comprise a coordination entity 401 (e.g., an MCE). The MC/BC GW 305 may use, for example, a GTP, such as GTPv.2, to communicate session stop requests with the coordination function node 303. In step 1304, the coordination function node 303 and/or the coordination entity 401 may report, to the MC/BC GW 305, the result of the request via a session stop response message.

In one or more of the procedures shown in FIGS. 8-13, signaling for error handling may be used in case of a delayed or failed response. For example, currently specified signalling for error handling, such as specified in 3GPP TS 23.246 v14.2.0 and 3GPP TS 36.300 v14.2.0, may be adapted and used. Where applicable, signalling described by these and/or other standards, as sent to (or from) a conventional MBMS GW in pre-existing systems, could instead be sent to (or from) a MC/BC gateway in one or more of the procedures shown in FIGS. 8-13. Similarly, and where applicable, signalling described by these and/or other standards, as sent to (or from) a conventional MCE in pre-existing systems, could instead be sent to (or from) a coordination function node in one or more of the procedures shown in FIGS. 8-13.

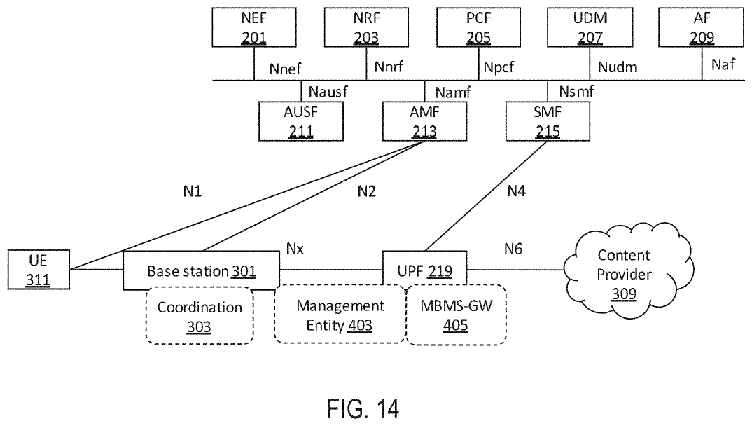

FIG. 14 is a block diagram of an example communication system in which one or more embodiments may be implemented. For example, FIG. 14 shows an example of an extension of the architecture approach of FIGS. 3-5, from a 5G system perspective. In the example implementation of FIG. 14, the role of the MC/BC gateway may be adopted by a User Plane Function (UPF) 219 based on related enhancements, with an Nx interface having similar characteristics as the virtual (e.g., Mx) interface discussed above. FIG. 14 assumes a distributed coordination function node 303 (which may comprise a coordination entity 401), but the proposed methods and related signalling may also be applied to a system using a centralized coordination function node 303 and/or coordination entity 401.

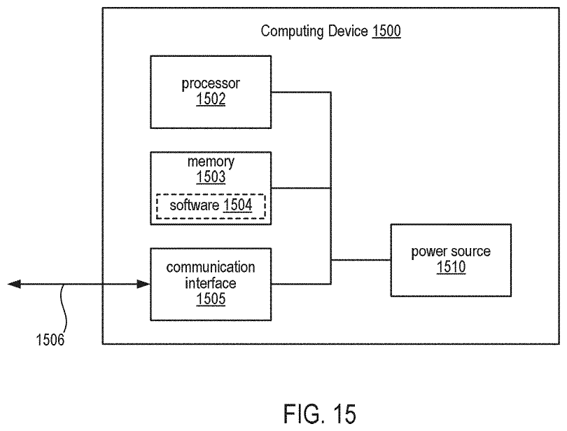

FIG. 15 illustrates an example apparatus, in particular a computing device 1500, that may be used in a communication network such as is described in any of the previous drawing figures. A computing device 1500 may be used to perform the herein described operations of a coordination function node (e.g., under the example implementation of FIG. 4 or of FIG. 5), an MC/BC gateway (e.g., under the example implementation of FIG. 4 or of FIG. 5), a service center (e.g., under the example implementation of FIG. 4 or of FIG. 5), one or more other devices described herein, or other network element. Each of a coordination function node, an MC/BC gateway, and/or a service center may be a separate computing device 1500.

Computing device 1500 may include circuitry, such as for example one or more processors 1502 and one or more memory 1503 storing software 1504. The software 1504 may comprise, for example, machine-readable, machine executable instructions that, when read and executed by processor 1502, cause computing device 1500 to perform the herein described operations, e.g., of a coordination function node, of an MC/BC gateway, of a service center, and/or of other network elements.

Computing device 1500 may comprise one or more power sources 1510. Examples of a power source 1510 may include a battery or a power supply to convert AC mains voltage to an appropriate DC voltage. Computing device 1500 may further comprise one or more communication interfaces 1505. Interface 1505 comprises circuitry to send and receive data over a physical medium 1506 according to a known standard. In some embodiments, interface 1505 may be an Ethernet interface. A computing device 1500 performing the operations of one of the elements described herein (e.g., an MC/BC gateway) may use its interface 1505 to communicate with other computing devices 1500, via interfaces 1505 of those other computing devices. Those other computing devices may perform the operations of other elements described herein (e.g., a coordination function node or a service center).

Memory 1502 may include any of various types of tangible machine-readable storage medium, including one or more of the following types of storage devices: read only memory (ROM) modules, random access memory (RAM) modules, magnetic tape, magnetic discs (for example, a fixed hard disk drive or a removable floppy disk), optical disk (for example, a CD-ROM disc, a CD-RW disc, a DVD disc), flash memory, and EEPROM memory. As used herein, a tangible or non-transitory machine-readable storage medium is a physical structure that may be touched by a human. A signal would not by itself constitute a tangible or non-transitory machine-readable storage medium, although other embodiments may include signals or ephemeral versions of instructions executable by one or more processors to carry out one or more of the operations described herein.

As used herein, processor 1502 may include any of various types of well-known computing structures including but not limited to one or more microprocessors, special-purpose computer chips, field-programmable gate arrays (FPGAs), controllers, application-specific integrated circuits (ASICs), combinations of hardware/firmware/software, or other special or general-purpose processing circuitry.

As used in this application, the term ‘circuitry’ may refer to any or all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a computing device, to perform various functions) and (c) to circuits, such as a microprocessor(s) or a portion of a microprocessor(s), that require software or firmware for operation, even if the software or firmware is not physically present. These examples of ‘circuitry’ apply to all uses of this term in this application, including in any claims. As an example, as used in this application, the term “circuitry” would also cover an implementation of merely a processor (or multiple processors) or portion of a processor and its (or their) accompanying software and/or firmware. The term “circuitry” would also cover, for example, a baseband integrated circuit or applications processor integrated circuit or a similar integrated circuit in a computing device.

Embodiments comprise any and all combinations, sub-combinations, and permutations of structure, operations, and/or other features described herein and in the accompanying drawing figures.

1.-23. (canceled)

24. An apparatus comprising:
one or more processors; and
memory storing machine-readable instructions executable by the one or more processors to cause the apparatus to:
connect the apparatus to a node via a control plane interface, wherein the node is associated with a base station configured to provide one or more of multicast transmissions or broadcast transmissions to user devices from a broadcast multicast core network;
connect the apparatus to the base station via a user plane interface;
send, to the node and via the control plane interface, one or more control signals; and
send, to the base station and via the user plane interface, one or more user signals.

25. The apparatus of claim 24, wherein the memory stores machine-readable instructions executable by the one or more processors to cause the apparatus to:
receive, from a broadcast multicast service center of the broadcast multicast core network, a request to initiate a broadcast multicast session, wherein the request comprises a plurality of session attributes; and
store the plurality of session attributes,
wherein sending the one or more control signals comprises sending, to the node and via the control plane interface, one or more of the plurality of session attributes.

26. The apparatus of claim 25, wherein the plurality of session attributes comprises two or more of an access indicator, a service area, quality of service (QoS) information, a session duration, a session identifier, or a mobile group identity.

27. The apparatus of claim 25, wherein the memory stores machine-readable instructions executable by the one or more processors to cause the apparatus to:
receive, from the broadcast multicast service center of the broadcast multicast core network, a request to update the broadcast multicast session, wherein the request to update comprises a second plurality of session attributes; and
store the second plurality of session attributes,
wherein sending the one or more control signals comprises sending, to the node and via the control plane interface, one or more of the second plurality of session attributes.

28. The apparatus of claim 25, wherein the memory stores machine-readable instructions executable by the one or more processors to cause the apparatus to:
receive, from the broadcast multicast service center of the broadcast multicast core network, a request to stop the broadcast multicast session,
wherein sending the one or more control signals comprises forwarding, to the node and via the control plane interface, the request to stop the broadcast multicast session.

29. The apparatus of claim 24, wherein the apparatus comprises a management entity, wherein the node comprises a coordination entity, wherein connecting the apparatus to the node comprises connecting the management entity to the coordination entity, and wherein sending the one or more control signals comprises sending, by the management entity and to the coordination entity, the one or more control signals.

30. The apparatus of claim 24, wherein the memory stores machine-readable instructions executable by the one or more processors to cause the apparatus to:
before connecting the apparatus to the node via the control plane interface, send, to the node and via a virtual interface, a request to set up the control plane interface between the apparatus and the node; and
receive, from the node and via the virtual interface, a response indicating setup of the control plane interface between the apparatus and the node.

31. The apparatus claim 24, wherein the node comprises a management entity and a coordination entity, wherein connecting the apparatus to the node comprises connecting the apparatus to the management entity, and wherein sending the one or more control signals comprises sending, to the management entity, the one or more control signals.

32. A method comprising:
connecting a multicast broadcast gateway to a node via a control plane interface, wherein the node is associated with a base station configured to provide one or more of multicast transmissions or broadcast transmissions to user devices from a broadcast multicast core network;
connecting the multicast broadcast gateway to the base station via a user plane interface;
sending, by the multicast broadcast gateway, to the node, and via the control plane interface, one or more control signals; and
sending, by the multicast broadcast gateway, to the base station, and via the user plane interface, one or more user signals.

33. The method of claim 32, further comprising:
receiving, by the multicast broadcast gateway and from a broadcast multicast service center of the broadcast multicast core network, a request to initiate a broadcast multicast session, wherein the request comprises a plurality of session attributes; and
storing the plurality of session attributes,
wherein sending the one or more control signals comprises sending, to the node and via the control plane interface, one or more of the plurality of session attributes.

34. The method of claim 33, wherein the plurality of session attributes comprise two or more of an access indicator, a service area, quality of service (QoS) information, a session duration, a session identifier, or a mobile group identity.

35. The method of claim 33, further comprising:
receiving, by the multicast broadcast gateway and from the broadcast multicast service center of the broadcast multicast core network, a request to update the broadcast multicast session, wherein the request to update comprises a second plurality of session attributes; and
storing the second plurality of session attributes,
wherein sending the one or more control signals comprises sending, to the node and via the control plane interface, one or more of the second plurality of session attributes.

36. The method of claim 33, further comprising:
receiving, by the multicast broadcast gateway and from the broadcast multicast service center of the broadcast multicast core network, a request to stop the broadcast multicast session,
wherein sending the one or more control signals comprises forwarding, to the node and via the control plane interface, the request to stop the broadcast multicast session.

37. The method of claim 32, wherein the multicast broadcast gateway comprises a management entity, wherein the node comprises a coordination entity, wherein connecting the multicast broadcast gateway to the node comprises connecting the management entity to the coordination entity, and wherein sending the one or more control signals comprises sending, by the management entity and to the coordination entity, the one or more control signals.

38. The method of claim 32, further comprising:
before connecting the multicast broadcast gateway to the node via the control plane interface, sending, by the multicast broadcast gateway, to the node, and via a virtual interface, a request to set up the control plane interface between the multicast broadcast gateway and the node; and
receiving, by the multicast broadcast gateway, from the node, and via the virtual interface, a response indicating setup of the control plane interface between the multicast broadcast gateway and the node.

39. The method of claim 32, wherein the node comprises a management entity and a coordination entity, wherein connecting the multicast broadcast gateway to the node comprises connecting the multicast broadcast gateway to the management entity, and wherein sending the one or more control signals comprises sending, to the management entity, the one or more control signals.

40. An apparatus comprising:
one or more processors; and
memory storing machine-readable instructions executable by the one or more processors to cause the apparatus to:
connect the apparatus to a first node in a multicast/broadcast core network via a control plane interface and a user plane interface;
connect the apparatus to a second node in a unicast core network via a second control plane interface;
connect the apparatus to a third node in the unicast core network via a second user plane interface;
receive, from the first node and via the control plane interface, one or more control signals for multicast/broadcast management; and
receive, from the first node and via the user plane interface, one or more user signals.

41. The apparatus of claim 40, wherein receiving the one or more control signals comprises receiving one or more of a plurality of session attributes associated with a multicast/broadcast session.

42. The apparatus of claim 41, wherein the plurality of session attributes comprise two or more of an access indicator, a service area, quality of service (QoS) information, a session duration, a session identifier, or a mobile group identity.
